(19) United States
(12) Patent Application Publication
(10) Pub. No.: US 2016/0139601 A1
(43) Pub. Date: May 19, 2016

(54) SYSTEMS AND METHODS FOR ATTITUDE CONTROL OF TETHERED AEROSTATS

(71) Applicant: Altaeros Energies, Inc., Somerville, MA (US)

(72) Inventors: Christopher R. Vermillion, Boston, MA (US); Benjamin W. Glass, Somerville, MA (US); Andrew D. Goessling, Boston, MA (US)

(21) Appl. No.: 14/943,008

(22) Filed: Nov. 16, 2015

Related U.S. Application Data
(63) Continuation-in-part of application No. 13/621,537, filed on Sep. 17, 2012, now Pat. No. 9,187,165.
(60) Provisional application No. 61/537,102, filed on Sep. 21, 2011.

(51) Int. Cl. G05D 1/08; B64F 3/00; B64B 1/50

(52) U.S. Cl. CPC G05D 1/0816; B64B 1/50; B64F 3/00; B64B 2201/00

(57) ABSTRACT

A control system for a tethered aerostat is provided, where at least one rotational and at least one translational degree of freedom are controlled to setpoints through the variation of tether lengths by an actuator system. The term tether includes a single tether, a tether group or a sub section of tether controlled by an individual actuator. Accurate rotational and translational control is essential for the successful operation of an aerostat under several applications, including surveillance, weather monitoring, communications, and power generation. For a given use case, the controller can be constructed and arranged to manage the tradeoff between several key performance characteristics, such as transient performance, steady-state pointing accuracy, tether tension regulation, and power generation.

### RELATED APPLICATIONS

This application is a continuation-in-part of co-pending U.S. patent application Ser. No. 13/621,537, filed Sep. 17, 2012, entitled SYSTEMS AND METHODS FOR ATTITUDE CONTROL OF TETHERED AEROSTATS, which claims the benefit of co-pending U.S. Provisional Application Ser. No. 61/537,102, filed Sep. 21, 2011, entitled SYSTEMS AND METHODS FOR ATTITUDE CONTROL OF TETHERED AEROSTATS, the entire disclosure of each of which applications is herein incorporated by reference.

### FIELD OF THE INVENTION

The present invention relates to control systems and methods of tethered aerostats.

### BACKGROUND OF THE INVENTION

Moored (tethered) aerostats have had widespread use in several applications, including surveillance, advertising, and weather monitoring, where the aerostat's stationary position and altitude control allows its objective to be carried out successfully. There has been an increased desire to substitute tethered aerostats or kite-based systems for traditional wind turbines in order to deliver significantly more wind energy than a traditional turbine at a fraction of the cost. In all of these applications, it is desirable that the altitude of the aerostat be controlled and that the aerostat remains steady during operation. For wind energy generation applications, aerostat-based systems offer an advantage over kite-based systems due to the fact that they are based on well-established core technology and include a “lighter-than-air” (often helium) lifting body that provides upward force even in the absence of wind. Still, because such aerostats are often affected by aerodynamic as well as buoyant forces, poor control over attitude can disadvantageously lead to loss of dynamic stability. Furthermore, in applications such as wind energy generation, the performance of the system is contingent not only on altitude control but also on the ability for the aerostat to point in a desirable direction, where the direction that the aerostat points is referred to as its “attitude”.

Prior systems have concentrated on altitude control for tethered aerostats, providing a configuration for which the aerostat remains stationary but is not controlled to a particular attitude. Furthermore, several concepts, such as the method and apparatus described in U.S. Pat. No. 5,080,302, filed Sep. 5, 1990, entitled METHOD AND APPARATUS FOR AERIALLY TRANSPORTING LOADS, by Hoke, provide for this stability by leading the tethers to points on the ground that are widely separated. This type of design requires an elaborate ground station for control of the aerostat altitude and requires an additional pivot at altitude for the aerostat to passively orient itself into the wind, a requirement that is essential for energy generation. Accordingly, there is a need for a system that provides control for a system effectively and efficiently by lessening the need for external control devices and/or sophisticated calibration algorithms, to control attitude of a tethered aerostat.

### SUMMARY OF THE INVENTION

To overcome the disadvantages of the prior art, in accordance with an illustrative embodiment this invention employs two or more actuators, originating from a single actuator platform on the ground, to control the aerostat altitude and at least one independent attitude variable. This lessens need for additional control in terms of camera adjustment for surveillance and reduces the need for sophisticated calibration algorithms on weather instrumentation that is mounted on the aerostat. Furthermore, for power generation applications, altitude control allows the aerostat to seek the optimal altitude for wind strength, without exceeding its rated capacity, and attitude control allows for further optimization of power generated, while also providing a mechanism for ensuring system stability when aerodynamic forces dominate buoyant forces.

A control system for a tethered aerostat includes an actuator system for accurate rotational and translational control of the aerostat. In an illustrative embodiment, a tethered aerostat is connected to an actuation platform via tethers. The actuation platform includes at least two independent actuators that control a control variable of the tethers attached to the actuators. By way of example, the control variable may be tether payout length, tether release speed, tether acceleration, tether slip threshold, tether tension, actuator platform angular orientation (heading), actuator platform angular speed, and actuator platform angular acceleration. Illustratively, the aerostat is connected to the actuator system via at least two tethers. The number of tethers is highly variable and typically includes at least two in an illustrative embodiment. According to the illustrative embodiment, each tether terminates at a single actuator on the actuation platform which has a control unit for providing input to the actuators in order to achieve the desired tether release rates, tether release acceleration, tether payout length, tether slip threshold, tether tension, actuator platform angular orientation (heading), actuator platform angular speed, and/or actuator platform angular acceleration, as well as maximum thresholds for variables, so that for example, tension above a certain threshold can result in additional tether being released so as to avoid excessive tension that would result in an increased risk of tether breakage. The control unit provides commands to the actuators in order to regulate at least two independent position and/or orientation (attitude) variables.

### BRIEF DESCRIPTION OF THE DRAWINGS

The invention description below refers to the accompanying drawings, of which:

FIG. 1 is a schematic diagram of the overall system architecture for an aerostat as tethered to an actuation platform, according to an illustrative embodiment;

FIG. 2 is a schematic diagram of a top view of an actuator platform of the system, according to the illustrative embodiment;

FIG. 3 is a block diagram of the various inputs and areas of control for the combination and restriction process, according to the illustrative embodiment;

FIG. 4 is a diagram of a side view of an aerostat and its various components, according to the illustrative embodiment;

FIG. 5 is a block diagram of the various stages for determining setpoints of a reference governor in accordance with the illustrative embodiment; and

FIG. 6 is a flow diagram of the modal control for operation of the main controller, in accordance with the illustrative embodiment.

### DETAILED DESCRIPTION

According to various illustrative embodiments, a control system for a moored (or tethered) aerostat varies the tether lengths through an actuator system. The term “tether” as used herein refers to a single tether, a group of tethers or a sub-section of tether controlled by an individual actuator or any other combination of tethers known to those ordinarily skilled in the art. The fabric and materials used for tethers is highly variable within ordinary skill. Accurate rotational and translational control of an aerostat is highly desirable for the successful operation of an aerostat. The location of an aerostat can be described in a Euclidean 3-dimensional space using three dimension coordinates. Translational control means controlling the location of the aerostat in at least one dimension. The rotational orientation of an aerostat can be described in a Euclidean 3-dimensional space using Euler angles. Rotational control means controlling the rotational orientation of the aerostat with regard to at least one axis. There are several applications for aerostats, including surveillance, weather monitoring, communications, and power generation, among others. The controller manages the tradeoff between several key performance characteristics, such as transient performance, steady-state pointing accuracy, tether tension regulation and power generation, as described in greater detail hereinbelow. Furthermore, in applications such as wind energy generation, the performance of the system is contingent not only on altitude control but also on the ability for the aerostat to point in a desirable direction, where the direction that the aerostat points is referred to as its “attitude”. For useful background information relating to various embodiments of aerostats and energy-producing turbines, refer to commonly assigned U.S. application Ser. No. 12/579,839, filed Oct. 15, 2009, entitled POWER-AUGMENTING SHROUD FOR ENERGY-PRODUCING TURBINES, by Benjamin W. Glass, the entire disclosure of which is herein incorporated by reference.

In an illustrative embodiment, the system described herein uses extremum seeking control for determination of an altitude setpoint, in which the altitude of the system is periodically perturbed and power output is evaluated. In the embodiment, the altitude setpoint is adjusted in a direction in which power output is observed to be increasing.

In another illustrative embodiment, the system described herein is a model predictive control (MPC) system for determination of setpoints, in which a trajectory of setpoints is computed in order to deliver optimal performance over a receding horizon. For example, for a horizon length of ^{N} steps, which comprises ^{NT} seconds, where ^{T} is the controller time step (in seconds), the MPC system is set up to minimize a cost function:

$$l ( x ( k ) , r ( k ) ) = u {\sum }_{i = k}^{k + N - 1} g ( x ( i \vert k ) , r ( j \vert k ) )$$

Subject to constraints:

x(j|k) [symbol] X,i=k . . . k+N−1

r(j|k) [symbol] R,i=k . . . k+N−1

where ^{x} represents the state of the system and ^{r} represents the manipulated variables (in this case, pitch, roll, and altitude setpoints) to the system. The stage cost, ^{g}, can consist of as many terms as desired to properly characterize the performance properties of the system that are to be traded off. Furthermore, as many constraints as appropriate can be incorporated to maintain the optimization problem as feasible. In an illustrative embodiment, the stage cost consists of a term for power usage, another term for transient performance, and a state constraint for tether tension.

In order to limit the amount of energy consumed by the actuator system, and ensure that the actuator system does not remain continuously active during the course of operation, the various illustrative embodiments are constructed and arranged such that the controller incorporates a deadband. In this deadband the control signal can be equal to approximately 0 whenever certain prescribed signals are sufficiently close to their desired values. Taking a control input, for example, tether release rate, at discrete time instant ^{k} as ^{u(k)} and a generic performance variable at time instant ^{k} as ^{y(k)}, this deadband is implemented as an adjustment of the raw control input, u^{raw} (before the deadband is applied) as follows:

u(k)=u^{raw}(k),|y|>y^{deadband}

O, otherwise

In general, there is no limit to the number of variables on which the deadband can apply.

According to an illustrative embodiment, a hysteresis loop is incorporated within the controller, such that the deadband entry criteria differs from the deadband exit criteria. The application of the deadband is modified as follows, taking u(k) as the control input, in accordance with the illustrative embodiment:

u(k)=u^{raw}(k),|y|>y^{deadband}

O, otherwise if |u(k−1)|=0

u(k)=u^{raw}(k),|y|>y^{deadband}

O, otherwise
otherwise

A power generation unit can be incorporated within or otherwise connected to the aerostat, which can consist primarily of at least one turbine and generator.

The generation unit can also include additional signal conditioning equipment (such as step-up transformers, for example), to transform the generated electrical signal to a higher voltage signal for the purpose of transmission to a base station. A conductive element can be included in one of the tethers used for control, or an additional tether can be provided for transmission of power to the base station. The energy-generation embodiment is applicable to the various illustrative embodiments described hereinabove. In an embodiment, telecommunications or other communications equipment can be incorporated within or otherwise connected to the aerostat.

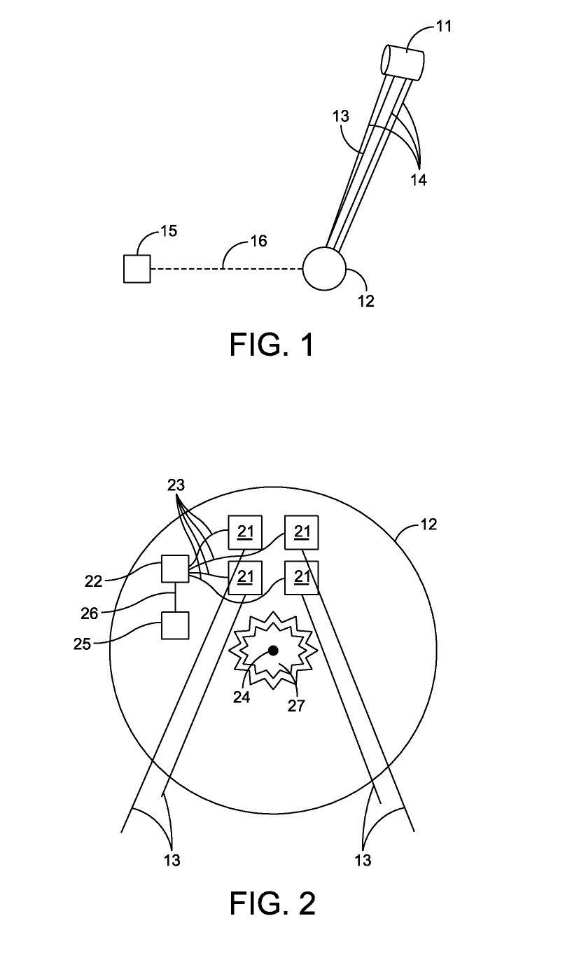

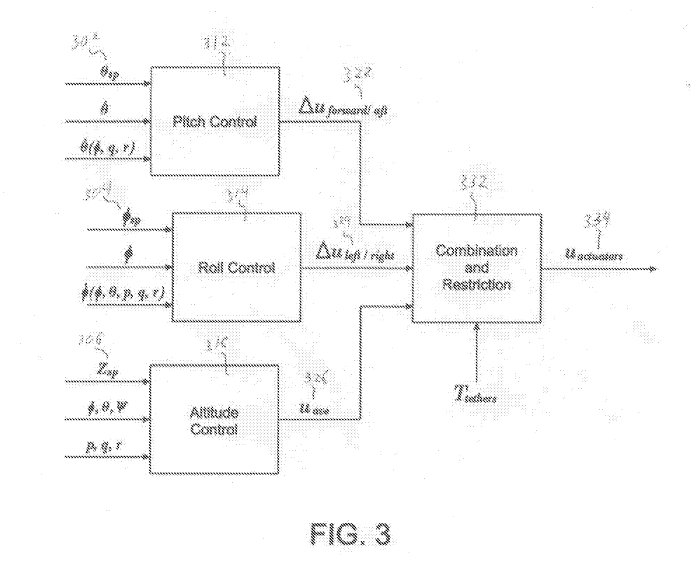

In accordance with an illustrative embodiment, a tethered aerostat 11 shown in FIGS. 1 and 2 is secured to an actuation platform 12 having at least 2 independent actuators 21 that control at least one tether control variable, such as tether release speed, for the aerostat tethers that are attached to the actuators. Controlling the release speeds of the tethers thereby controls the tether length. The aerostat 11 is connected to the actuator system via tethers 13. As shown in FIG. 2, each tether can terminate at a single actuator. A control unit 22 provides inputs (voltages or other inputs known in the art) to the actuators 21 to achieve desired tether release rates at the actuators. The control unit 22 can provide commands via communication links 23 to the actuators 21 to regulate at least two independent position and/or orientation variables, such as pitch angle and attitude. In an illustrative embodiment, the actuators can be electric winches. The actuation platform 11 is free to rotate about a pivot axis 24. In an illustrative embodiment, for example as shown in FIG. 3, the control system drives pitch angle, ^{θ}, to a feasible setpoint, ^{θ}sp 302, drives roll angle, φ, to a feasible setpoint, ^{φ}sp 304, and regulates altitude, ^{z}, to a feasible setpoint, ^{z}sp 306. In the illustrative embodiment shown in FIG. 3, separate pitch controller 312, roll controller 314, and altitude controller 316 determine commands for the difference between the forward and aft tether release rates (^{Δu}forward/aft) 322, the difference between the left and right tether release rates (^{Δu}left/right) 324, and the average tether release rate (^{u}ave) 326, respectively. These separate commands are then aggregated in a subsequent block 332 via a relationship such as:

^{u}front,left=^{u}ave+^{Δu}forward/aft+^{Δu}left/right

^{u}front,right=^{u}ave+^{Δu}forward/aft−^{Δu}left/right

^{u}aft,left=^{u}ave−^{Δu}forward/aft+^{Δu}left/right

^{u}aft,right=^{u}ave−^{Δu}forward/aft−^{Δu}left/right

where ^{u}actuators 334 represents a control variable command, such as a tether release rate command. In an embodiment, an aerostat can be autonomously controlled by a remote computer 15, control unit 22, and/or data processing device 44 that uses the above described system.

In a further embodiment, a tethered aerostat 11 shown in FIGS. 1 and 2 is tethered to an actuation platform 12 having at least 2 independent actuators 21 that control a control variable of the aerostat tethers that are attached to the actuators. The control variable may be, by way of example, any one of tether payout length, tether release speed, tether acceleration, or tether tension, as well as maximum thresholds for variables, so that for example, tension above a certain threshold can result in additional tether being released so as to avoid excessive tension that would result in an increased risk of tether breakage. The aerostat 11 is connected to the actuator system via tethers 13. As shown in FIG. 2, each tether terminates at a single actuator. A control unit 22 can provide inputs (voltages or other inputs known in the art) to the actuators 21 to achieve desired value of the tether control variable. The control unit 22 can provide commands via communication links 23 to the actuators 21 to regulate at least one independent position and/or orientation variables, such as pitch angle, altitude, and/or attitude.

An optional remotely-operated host computer 15 allows the user to interact with the system via a communication link 16, which can be wired or wireless. Communication can occur between the remote computer 15 and the base station control unit 22, between a remote computer 15 and a data processing device 44, or can be communicated directly between the remote computer 15 and at least one actuator 21. According to an illustrative embodiment, the communication link of 16 is bi-directional, allowing a remote user to input commands to the actuator platform 12 and receive data (telemetry) from it. The communication link 16 can also be uni-directional to allow for uni-directional flow of data from the actuator platform to the remote user and vice versa. Optionally, the remotely-operated host computer can autonomously control the aerostat using the control systems described herein.

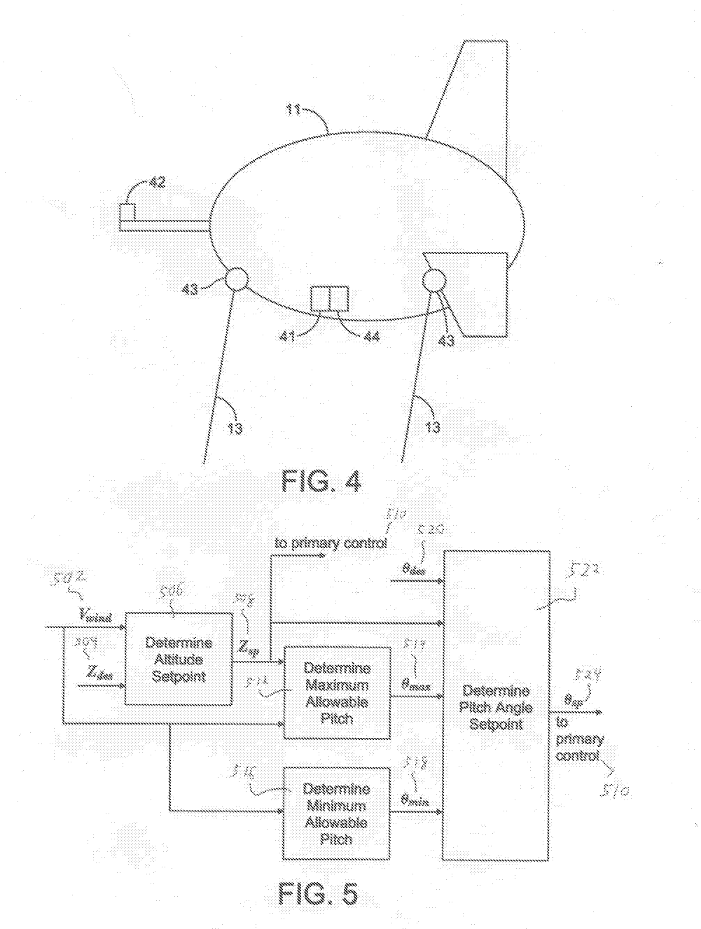

An additional data processing device 44 can be provided, such as a microcontroller or rapid prototyping board, that receives and aggregates the data from the measurement units on the aerostat 11 and sends this data through the conductive cable element to the control unit 22 via the aforementioned communication link 14. See FIG. 4 for example. This aerostat data processing device 44 can include filters (for example for extracting important information from noisy signals or blending several measurements), as well as algorithms for prioritizing and timing the dissemination of data packets through the conductive tether to the control unit 22.

A wind measurement unit 42 can be employed to measure wind velocities and communicate these measurements to the base station control unit 22 via the communication link 14, in accordance with ordinary skill.

A tension measurement device 43 can be employed, such as a load cell or strain gauge, to measure the tension within at least one tether and communicate this measurement to the control unit 22 via the communication link 14. As illustrated in FIG. 4, this tension is measured at the point of attachment between the tethers and shroud. In further embodiments, the tension is measured at the base station through load cells that measure the reaction between the actuators and base station.

The “Combination and Restriction” element or process in FIG. 3 is constructed and arranged to limit tether release commands whenever tether tensions fall below a specified threshold. In an illustrative embodiment, this block limits both forward release rate commands to a maximum of approximately 0, indicating that tether can be pulled in but not released, any time that all forward tether tensions fall below the threshold. The combination and restriction process also restricts both aft tether release rate commands to a maximum of approximately 0 any time that all aft tether tensions fall below the threshold. In another illustrative embodiment, the combination and restriction block limits both forward release rate commands to a maximum of approximately 0 any time that the average forward tether tension falls below the threshold and limits both aft tether release rate commands to a maximum of approximately 0 any time that the average aft tether tension falls below the threshold. In another illustrative embodiment, the combination and restriction block includes a tether tension controller that computes separate tension-based control input commands for each tether. In the illustrative embodiment, the final control commands are taken as the minimum of the tension-based control input commands and the original input commands, u_{front,left}, u_{front,right}, u_{aft,left}, and u_{aft,right}, derived from altitude, pitch and roll controllers.

As shown in FIG. 4, an inertial measurement unit (IMU) 41, can be included in or on the aerostat 11, which can measure roll, pitch, and yaw angles in Euler angles, as well as their rates of change. A communication link 14 can be provided (for example, a hard-wired or wireless communication), which can communicate measured attitude and rate measurements between the aerostat 11 and the control unit 22.

A pivot axis 24 is defined on the actuator platform 12, which includes a heading sensor 25 such as a magnetometer, and a communication link 26 between the heading sensor and the control unit 22. In an embodiment, actuator platform 12 can rotate freely about pivot axis 24. A rotational actuator 27 can also be optionally employed and can be used to actively alter the heading of the actuator platform. The heading reading from the sensor 25 is used in conjunction with the shroud heading from its IMU 41 of the aerostat 11 to compute the appropriate control input to the rotational actuator 27.

In a further embodiment, the control unit 22 can provide commands via communication links 23 to the rotational actuator 27 to control a control variable of the actuator platform 12. The control variable of the actuator platform may be, by way of example, actuator platform angular orientation (heading), actuator platform angular velocity, or actuator platform angular acceleration. Changing the actuator platform angular orientation can effectively change the tether tensions, which can affect aerostat position and orientation. The control unit 22 provides commands via communication links 23 to the rotational actuator 27 to regulate at least one independent position and/or orientation variables of the aerostat, such as pitch angle and attitude.

Turning now to FIG. 5, shown is an exemplary block diagram of an embodiment of various stages for determining setpoints of a reference governor. Input V_{wind} (wind velocity) 502 and input Z_{des} (desired altitude) 504 can be used in stage 506 to determine altitude setpoint Zₛₚ (altitude setpoint) 508. Zₛₚ 508 can then be communicated to primary control 510 for use as a control variable. Primary control 510 can be control unit 22. Zₛₚ 508 and V_{wind} 502 can be used as inputs to stage 512 to determine the maximum allowable pitch Θₘₐₓ 514. V_{wind} 502 is also used as an input in stage 516 to determine minimum allowable pitch, Θₘᵢₙ 518. The desired pitch, Θ_{des} 520, Zₛₚ 508, Θₘₐₓ 514, and Θₘᵢₙ 518, can be used as inputs to stage 522 to determine pitch angle setpoint, Θₛₚ 524. Θₛₚ 524 can then be communicated to primary control 510 for use as a control variable. In an embodiment, an aerostat can be autonomously controlled through the system described above by using various inputs to determine appropriate control variables that can be communicated to a primary control system 510 that can be control unit 22. An aerostat can be autonomously controlled through use of the above described system by data processing device 44, control unit 22, and/or a remote computer 15 utilizing at least one of a communication link to control unit 22 or a communication link to at least one actuator 21.

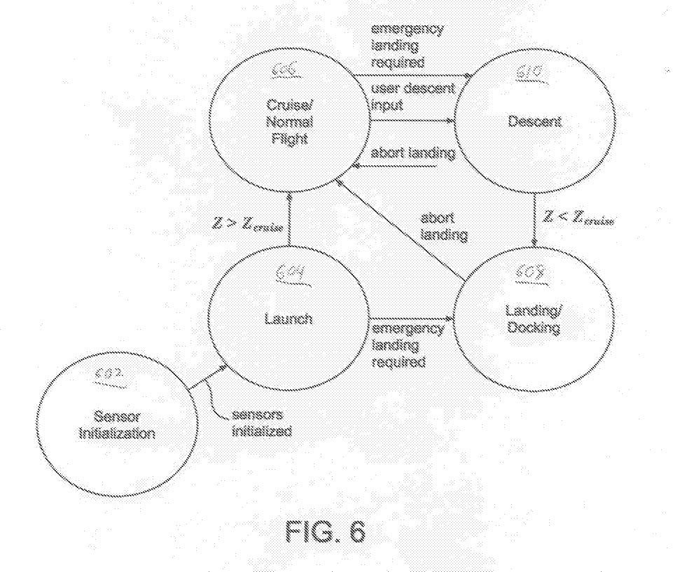

Turning now to FIG. 6, shown is a flow diagram of an illustrative embodiment of a modal control for operation of the main controller. Step 602 is sensor initialization. After sensors are initialized, an aerostat is launched in step 604, Launch. If altitude, Z, is greater than or equal to cruising altitude, Z_{cruise}, then the aerostat is in cruise/normal flight mode in step 606, Cruise/Normal Flight. If an emergency landing is required after launch, then proceed to step 608 Landing/Docking, where the aerostat can be landed/docked. If desired, the landing can be aborted, and the aerostat can be returned to normal flight mode in step 606, Cruise/Normal Flight. While the aerostat is in Cruise/Normal Flight step 606, it can proceed to descent mode in step 610, Descent. The aerostat can proceed from step 606, Cruise/Normal Flight, to step 610, Descent, if an emergency landing is required, or based on user descent input. In descent mode 610, Descent, altitude Z can be decreased until altitude Z is less than cruising altitude Z_{cruise}. When altitude Z is less than cruising altitude Z_{cruise}, the aerostat can enter landing/docking mode in step 608 Landing/Docking. While in descent mode, 610 Descent, the descent can be aborted and the aerostat returned to step 606, Cruise/Normal Flight. In an embodiment, an aerostat can be autonomously controlled through use of the above described system by data processing device 44, control unit 22, and/or a remote computer 15 utilizing at least one of a communication link to the control unit 22 or a communication link to at least one actuator 21.

The systems and methods herein also support constrained optimization-based determination of setpoints that can optionally be determined autonomously (free of user intervention). According to an illustrative embodiment, the control unit 22 for the main invention does not receive setpoints input by an external user but rather optimizes these setpoints internally via an optimal control technique. This advantageously allows users to trade off multiple performance objectives (for example, transient performance and tether tensions). In an embodiment, autonomous control of an aerostat can be implemented by at least one processor in data processing device 44, remote computer 15, and/or control unit 22.

The foregoing has been a detailed description of illustrative embodiments of the invention. Various modifications and additions can be made without departing from the spirit and scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, the teachings herein are applicable to a wide range, size and type of aerostats without departing from the scope of the present invention. Shape and contour of the aerostat are highly variable so long as they include the control systems and methods described herein. Additionally, directional and locational terms such as “top”, “bottom”, “center”, “front”, “back”, “above”, and “below” should be taken as relative conventions only, and not as absolute. Finally, the placement and location of actuators and tethers are highly variable so long as they are in accordance with the teachings shown and described herein. Accordingly, this description is meant to be taken only by way of example, and not to otherwise limit the scope of this invention.

What is claimed is:

1. A system for controlling a tethered aerostat, the system comprising:
a base station including an actuation platform having an actuator system that is secured to the tethered aerostat via a plurality of tethers;
the actuation platform having at least two actuators that each respectively control a control variable of at least some of the plurality of tethers; and
a control unit that provides input to at least one of the at least two actuators to control a control variable of the controlled tethers.

2. The system as set forth in claim 1 wherein the control variable is tether payout length.

3. The system as set forth in claim 1 wherein the control variable is tether release speed.

4. The system as set forth in claim 1 wherein the control variable is tether acceleration.

5. The system as set forth in claim 1 wherein the control variable is tether tension.

6. A system for controlling a tethered aerostat, the system comprising:
a base station including an actuation platform having an actuator system that is secured to the tethered aerostat via a plurality of tethers;
the actuation platform having at least two actuators that each respectively control a control variable of at least some of the plurality of tethers;
the actuation platform having an actuation platform rotational actuator that controls a control variable of the actuation platform; and
a control unit that provides input to the rotational actuator to control a control variable of the rotational actuator.

7. The system of claim 6, wherein the control variable of the actuation platform is actuation platform angular orientation.

8. The system of claim 6, wherein the control variable of the actuation platform Is actuation platform angular speed.

9. The system of claim 6, wherein the control variable of the actuation platform is actuation platform angular acceleration.
